(19) United States
(12) Patent Application Publication
(10) Pub. No.: US 2016/0285343 A1
(43) Pub. Date: Sep. 29, 2016

(54) MAGNETIC WINDBLOWN DEVICE

(71) Applicant: Jeteazy System Co., Ltd., Hsinchu City (TW)

(72) Inventors: Cheng-Hsin Tsai, Hsinchu City (TW); Jia-Cing Gong, Hsinchu City (TW); Po-Yuan Cheng, Hsinchu City (TW); Hung-Chieh Chen, Hsinchu City (TW); Ming-Hsiung Hung, Hsinchu City (TW)

(21) Appl. No.: 14/669,701

(22) Filed: Mar. 26, 2015

(51) Int. Cl. H02K 7/14; F04D 25/06; H02K 5/22; F04D 19/00

(52) U.S. Cl. CPC H02K 7/14; F04D 19/002; F04D 25/06; H02K 5/225

(57) ABSTRACT

A magnetic windblown device has a housing, a windblown assembly, a magnetic assembly, a power assembly, a decoration, and at least one magnetic element. The windblown assembly and the magnetic assembly are mounted inside the housing. The power assembly is mounted in the housing and is electrically connected to the windblown assembly and the magnetic assembly. The decoration and the magnetic element are mounted in the housing. The windblown assembly generates airflow to make the decoration swing. The magnetic assembly changes the magnetic field to rotate and move the magnetic element. Office staff feels relaxed and inspired by watching the swinging decoration and the rotating/moving magnetic element.

### BACKGROUND OF THE INVENTION

1. Field of the Invention

The present invention relates to a magnetic windblown device, and more particularly to a device generating airflow and magnetic field.

2. Description of the Related Art

As modern society operates in a pattern that emphasizes accuracy and efficiency, office staff must stay highly concentrated on business to handle various tasks correctly. Furthermore, as business interactions among different industries increase, numerous tasks and projects must be completed under strict deadlines. Therefore, office staff is continuously under high stress and tension for a long term, which results in career fatigue and low working efficiency. Meanwhile, the office staff's motivation for work will be affected.

Clinical data show that people are prone to tiredness and cardiovascular diseases, such as arrhythmia or hypertension, when they are continuously under high stress and tension for a long term. Besides, high tension or nervous emotion will depress people, leading to psychological trauma.

To release the long-term high tension at workplace, the present invention provides a magnetic windblown device with a windblown assembly generating airflow and a magnetic assembly changing magnetic field to mitigate or obviate the aforementioned problems.

### SUMMARY OF THE INVENTION

A main objective of the present invention is to provide a magnetic windblown device for releasing office staff's pressure at work.

To achieve the foregoing objective, the magnetic windblown device in accordance with the present invention comprises a housing, a windblown assembly, a magnetic assembly, and a power assembly. The housing has a through hole and multiple openings. The through hole is defined in one of two ends of the housing. The openings are defined in the housing. The windblown assembly has a motor and a fan. The motor is mounted inside the housing. The fan is mounted in the motor and corresponds in position to the through hole. The magnetic assembly has multiple magnets and multiple electromagnets. The magnets are mounted in the fan. The electromagnets are mounted inside the housing. The power assembly is mounted in the housing and is electrically connected to the motor and the electromagnets.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a magnetic windblown device in accordance with the present invention.

FIG. 2 is a side view of the magnetic windblown device in FIG. 1.

FIG. 3 is an exploded perspective view of the magnetic windblown device in FIG. 1.

FIG. 4 is a front view of the magnetic windblown device in FIG. 1, shown set up with a decoration.

FIG. 5 is a perspective view of the magnetic windblown device in FIG. 1, shown with multiple magnetic elements.

FIG. 6 is a front view of multiple magnetic-windblown devices in FIG. 1, shown assembled together and electrically connected.

### DETAILED DESCRIPTION OF THE INVENTION

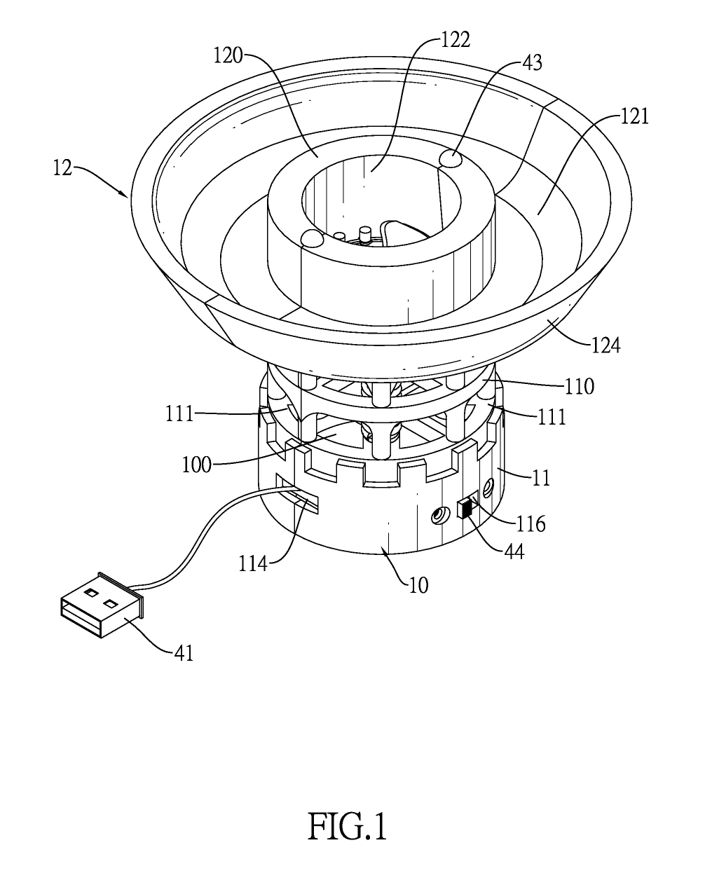

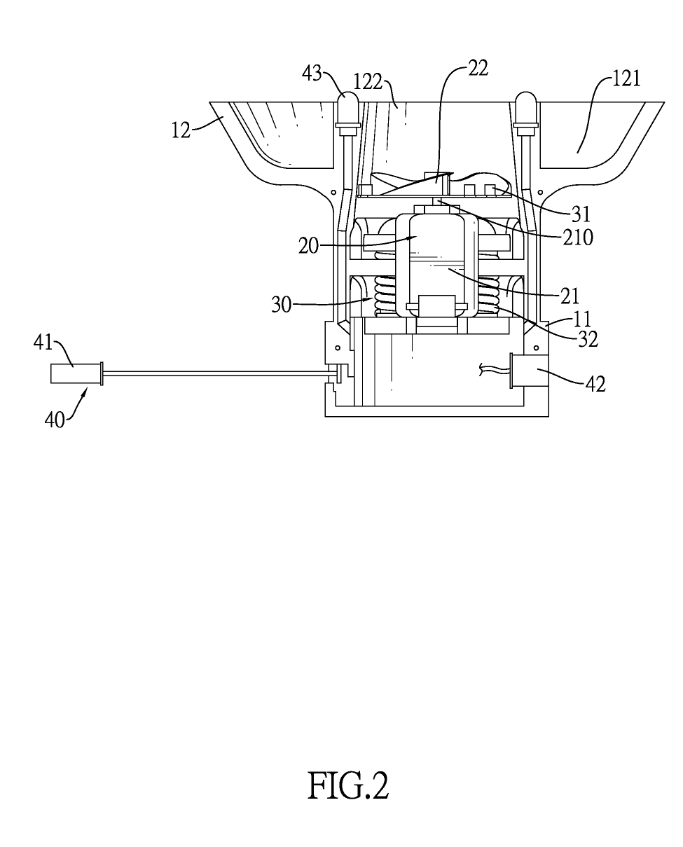

With reference to FIGS. 1 and 2, a magnetic windblown device in accordance with the present application comprises a housing 10, a windblown assembly 20, a magnetic assembly 30, and a power assembly 40. The magnetic windblown device may further have a decoration 50 and at least one magnetic element 60.

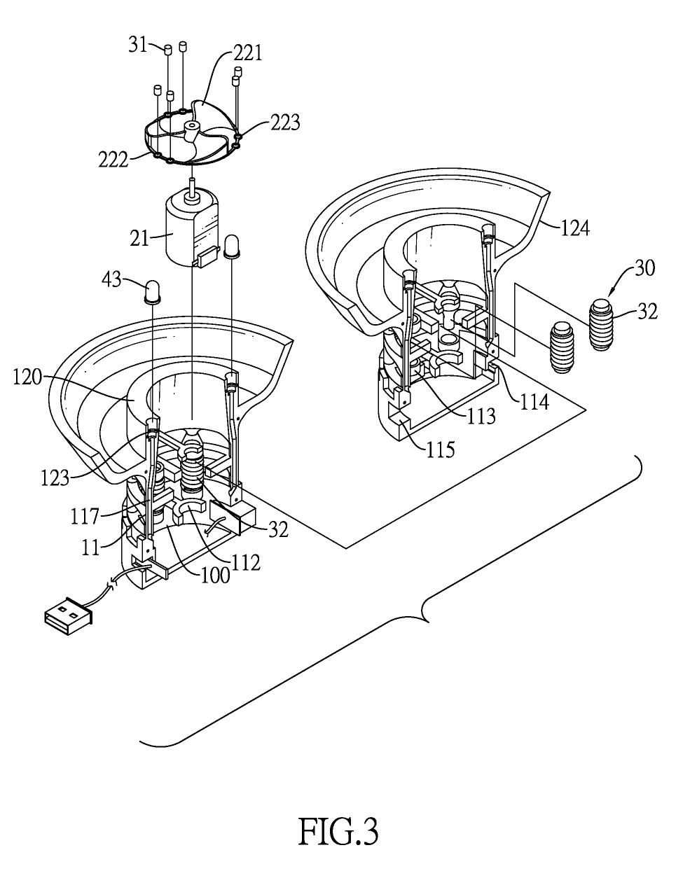

With reference to FIGS. 1 and 3, the housing 10 is hollow and has a base part 11, a basin part 12, and a chamber 100. The basin part 12 is formed in one of two ends of the base part 11. The chamber 100 is formed inside the base part 11. The housing 10 may be assembled by two blocks that have an identical structure.

The base part 11 has multiple openings 111, a mounting support 112, multiple mounting brackets 113, multiple mounting slots, and multiple wire-receiving grooves 117.

The openings 111 are defined in a sidewall 110 of the base part 11, are spaced apart at intervals, and communicate with the chamber 100.

The mounting support 112 protrudes from an inner wall of the base part 11. The mounting support 112 may be a pair of extending protrusions.

The mounting brackets 113 protrude from the inner wall of the base part 11 and are spaced apart at intervals. The mounting brackets 113 may be four pairs of extending protrusions.

The mounting slots are defined in the sidewall 110 of the base part 11 and away from the basin part 12 relative to the openings 111. The mounting slots may be a first mounting slot 114, a second mounting slot 115, and a third mounting slot 116, which are spaced apart at intervals.

The wire-receiving grooves 117 may be two in amount. The wire-receiving grooves 117 are axially defined in the sidewall 100 of the base part 11, are spaced apart at intervals, and may be defined between the two blocks of the housing 10 respectively.

The basin part 12 has a protruding wall 120, a recess 121, a through hole 122, and multiple mounting seats 123.

The protruding wall 120 protrudes from a middle of the basin part 12.

The recess 121 is formed between the protruding wall 120 and an annular sidewall 124 of the basin part 12.

The through hole 122 is defined in a middle of the protruding wall 120 and communicates with the chamber 100.

The mounting seats 123 may be two in amount. The mounting seats 123 are axially defined in the protruding wall 120, are spaced apart at intervals, are defined between the two blocks of the housing 10, and communicate with the wire-receiving grooves 117 of the base part 11 respectively.

With reference to FIGS. 2 and 3, the windblown assembly 20 is mounted inside the housing 10 and has a motor 21 and a fan 22.

The motor 21 is mounted in the mounting support 112 of the base part 11 of the housing 10 and has a shaft 210. The shaft 210 is disposed towards the through hole 122 of the basin part 12.

The fan 22 is mounted in the motor 21 and has a blade 221, a frame 222, and multiple mounting holes 223.

The blade 221 is mounted in the shaft 210 of the motor 21 and corresponds in position to the through hole 122.

The frame 222 is formed annually around the blade 221.

The mounting holes 223 are defined in the frame 222 and are spaced apart at intervals.

With reference to FIGS. 2 and 3, the magnetic assembly 30 is mounted inside the housing 10 and has multiple magnets 31 and multiple electromagnets 32.

The magnets 31 are mounted in the mounting holes 223 of the fan 22 respectively.

The magnetic assembly 30 may have four electromagnets 32. The electromagnets 32 are mounted in the mounting brackets 113 of the base part 11 of the housing 10 respectively.

With reference to FIGS. 1 and 2, the power assembly 40 is mounted in the housing 10 and has a circuit board, a male connector 41, a female connector 42, multiple lighting elements 43, and a variable-speed switch 44.

The circuit board is mounted inside the housing 10 and is electrically connected to the electromagnets 32 and the motor 21.

The male connector 41 and the female connector 42 may be USB connectors.

Also with reference to FIG. 3, the male connector 41 is mounted in the first mounting slot 114 of the base part 11 of the housing 10. One of two ends of the male connector 41 is electrically connected to the circuit board.

The female connector 42 is mounted in the second mounting slot 115 of the base part 11 of the housing 10. One of two ends of the female connector 42 is electrically connected to the circuit board.

The lighting elements 43 may be LEDs. The power assembly 40 may have two lighting elements 43 mounted respectively in the two mounting seats 123 of the basin part 12 of the housing 10. Two electrical wires of the lighting elements 43 are mounted respectively in the wire-receiving grooves 117 of the base part 11 and are electrically connected to the circuit board.

The variable-speed switch 44 is mounted in the third mounting slot 116 of the base part 11 of the housing 10 and is electrically connected to the circuit board.

The male connector 41 and the female connector 42 of the present invention are USB connectors for the convenience of office workers. Office workers can connect the magnetic-windblown device electrically to the computer or any device that has USB hubs at office. Furthermore, the male connector 41 is retractable. When the male connector 41 is electrically connected to an external power source, the male connector 41 is away from the housing 10. When the male connector 41 is retracted for storage, the male connector 41 abuts the housing 10. An office staff can adjust the variable-speed switch 44 to change a rotational speed of the fan 22, thereby adjusting amounts of airflow that flows through the housing 10.

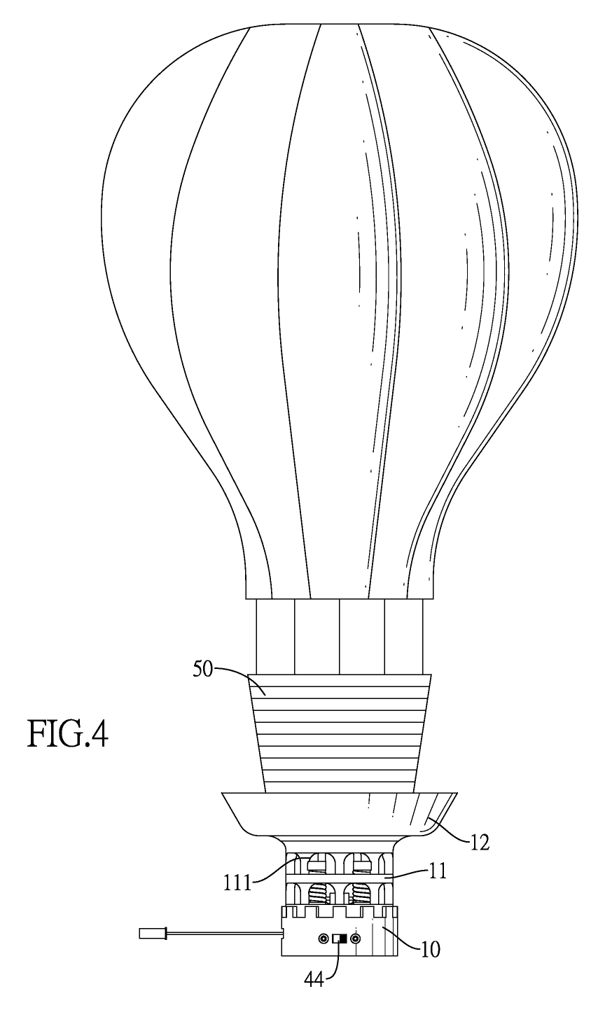

As shown in FIGS. 2 and 4, the office staff installs the decoration 50 in the basin part 12 of the housing 10. The decoration 50 may be a balloon-like figure. As the office staff connects the male connector 41 to the external power source, the motor 21 drives the fan 22 to rotate. Air inflow is directed into the housing 10 from the openings 111 of the base part 11 of the housing 10 by the fan 22, and then airflow passes through the blade 221 and the through hole 122 sequentially and out of the housing 10, as shown in FIG. 1. Meanwhile, corresponding to light emitted by the lighting elements 43, the decoration 50 elevates and swings like a hot air balloon and emits light for catching attention of the office workers for releasing them temporarily from tension and pressure at work. The office staff can turn the variable-speed switch 44 to adjust airflow and thus the swinging degree of the decoration 50. Further, the decoration 50 may be a flame-like figure, a merry-go-round figure, or a swinging-man figure.

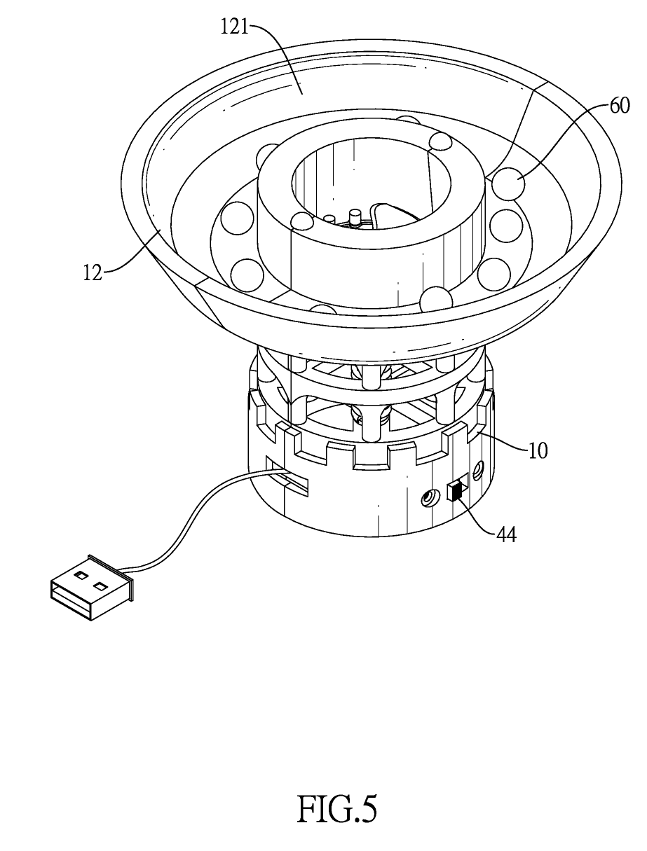

As shown in FIGS. 3 and 5, when the office staff connects the present invention to the external power source and puts at least one magnetic element 60 in the recess 121 of the basin part 12 of the housing 10, the at least one magnetic element 60 is attracted to and rotates with the magnets 31 that are mounted in the fan 22. Meanwhile, the electromagnets 32 are controlled by the power assembly 40 to be electrically connected or disconnected, and then the electromagnets 32 generate a magnetic hysteresis. The power assembly 40 applies a reverse current to the electromagnets 32, such that the electromagnets 32 generate a magnetic field of opposite polarity and are demagnetized. Therefore, the magnetic element 60 moves up and down recurrently in accordance with the continuous changes of the magnetic field of the electromagnets 32. Because of the magnets 31 and the electromagnets 32, the magnetic element 60 rotates and moves up and down recurrently in the recess 121. The magnetic element 60 may be an element having magnetism or a hollow element embedded with a magnet.

Besides, the office staff adjusts the variable-speed switch 44 to accelerate the rotation of the magnets 31 mounted in the fan 22, thereby attracting the magnetic element 60 to rotate. By watching the swinging decoration 50 and the rotating and moving magnetic element 60 of the present invention, the office staff feels relaxed and inspired, and is further motivated for work.

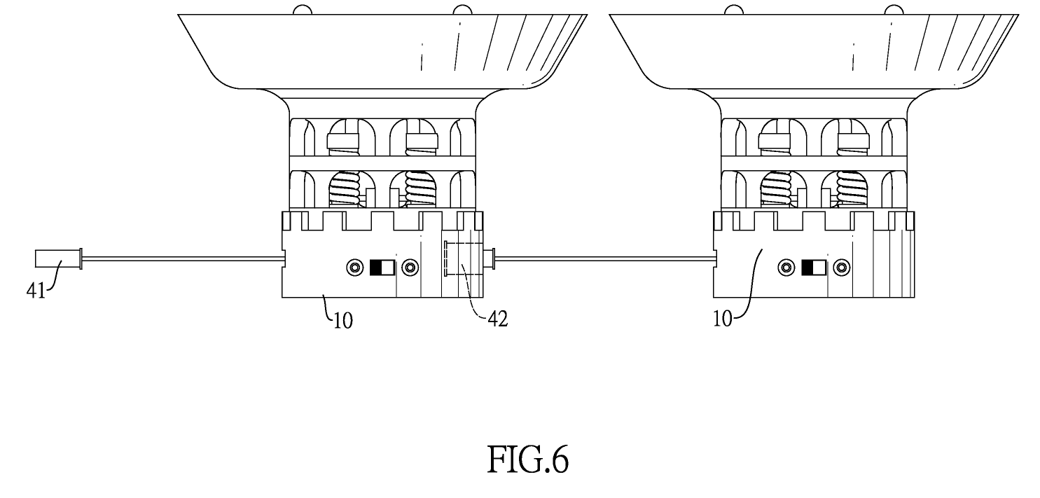

With reference FIG. 6, two magnetic windblown devices of the present invention are assembled for use. The office staff electrically connects the male connector 41 of a first one of the two magnetic windblown devices to a computer or any other device with USB hubs, and then the office staff connects the male connector 41 of the other magnetic windblown device to the female connector 42 of the first magnetic-windblown device. Multiple magnetic windblown devices of the present invention can be further combined in the above manner, such that the office staff can watch the decorations 50 swinging and the magnetic elements 60 rotating and moving to take a brief break from work.

Even though numerous characteristics and advantages of the present. invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A magnetic windblown device, comprising:
a housing being hollow and having
a through hole defined in one of two ends of the housing; and
multiple openings defined in the housing;
a windblown assembly having
a motor mounted inside the housing; and
a fan mounted in the motor and corresponding in position to the through hole;
a magnetic assembly having
multiple magnets mounted in the fan; and
multiple electromagnets mounted inside the housing; and
a power assembly mounted in the housing and electrically connected to the motor and the electromagnets.

2. The magnetic windblown device as claimed in claim 1, wherein the housing has
a base part having
a mounting support protruding from an inner wall of the base part; and
multiple mounting brackets protruding from the inner wall of the base part and spaced apart at intervals;
a basin part formed in one of two ends of the base part and having
a protruding wall protruding from a middle of the basin part;
a recess formed between the protruding wall and an annular sidewall of the basin part; and
multiple mounting seats axially defined in the protruding wall and spaced apart at intervals; and
a chamber formed inside the base part; wherein
the openings are defined in a sidewall of the base part, are spaced apart at intervals, and communicate with the chamber;
the through hole is defined in a middle of the protruding wall and communicates with the chamber;
the motor is mounted in the mounting support of the base part and has a shaft disposed towards the through hole of the basin part;
the fan is mounted in the shaft of the motor; and
the electromagnets are mounted in the mounting brackets of the base part.

3. The magnetic windblown device as claimed in claim 2, wherein the fan has
a blade mounted in the shaft of the motor and corresponding in position to the through hole;
a frame formed annually around the blade; and
multiple mounting holes defined in the frame and spaced apart at intervals;
the magnets are mounted in the mounting holes of the fan respectively.

4. The magnetic windblown device as claimed in claim 3, wherein the base part of the housing further has multiple mounting slots defined in the sidewall of the base part and away from the basin part relative to the openings;
the power assembly has
a male connector mounted in one of the mounting slots;
a female connector mounted in another one of the mounting slots;
multiple lighting elements mounted in the mounting seats respectively; and
a variable-speed switch mounted in still another one of the mounting slots.

5. The magnetic windblown device as claimed in claim 4, wherein the magnetic windblown device further has a decoration mounted in the basin part of the housing.

6. The magnetic windblown device as claimed in claim 5, wherein the magnetic windblown device further has at least one magnetic element mounted in the recess of the basin part of the housing.

7. The magnetic windblown device as claimed in claim 4, wherein the magnetic windblown device further has at least one magnetic element mounted in the recess of the basin part of the housing.
